(19) United States
(12) Patent Application Publication
(10) Pub. No.: US 2007/0122668 A1
(43) Pub. Date: May 31, 2007

(54) Fuel cell system and method of starting it

(75) Inventors: Keisuke Suzuki, Kanagawa-ken (JP); Shinichi Makino, Kanagawa-ken (JP); Hiromasa Sakai, Kanagawa-ken (JP); Ikuhiro Taniguchi, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD., Kanagawa (JP)

(21) Appl. No.: 10/580,838

(22) PCT Filed: Oct. 15, 2004
(86) PCT No.: PCT/JP04/15660

§ 371 Date: May 26, 2006

(30) Foreign Application Priority Data
Nov. 27, 2003 (JP) 2003-396795
Mar. 25, 2004 (JP) 2004-090115

(51) Int. Cl. H01M 8/04

(52) U.S. Cl. 429/22; 429/23

(57) ABSTRACT

A fuel cell system including: a fuel gas supply start command unit (101) for commanding start of a fuel gas supply to a fuel cell (1); a voltage detector (21) for detecting a fuel cell voltage; a control unit (103) for performing a deterioration preventing control for the fuel cell (1) based on the fuel cell voltage (CV) and a start command from the fuel gas supply start command unit (101); and another control unit (104) for controlling fuel gas feed rate according to the start command and the deterioration preventing control. The deterioration preventing control is performed at start-up of the fuel cell system. The fuel gas supply is started according to the start command, and after the deterioration preventing control is started, the fuel gas feed rate is increased.

### TECHNICAL FIELD

The present invention relates to a fuel cell system including a fuel cell which has electrodes containing catalysts supported on carbon catalyst carriers, particularly to a control for preventing deterioration of catalysts and catalyst carrier at start-up and shutdown of the fuel cell system.

### BACKGROUND ART

A fuel cell is an electrochemical device to convert chemical energy of fuel gas such as hydrogen gas and oxidizer gas containing oxygen supplied thereto, directly to electric energy which is extracted from electrodes provided on both sides of an electrolyte thereof. A Polymer Electrolyte Fuel Cell (PEFC) can operate at low temperature and be easily handled, because of the intrinsic nature of the material of a solid polymer electrolyte membrane used therein, and is therefore particularly suitable for vehicular power application. A fuel cell vehicle carries a hydrogen storage device, such as a high-pressure hydrogen tank, a liquid hydrogen tank, or a hydrogen storage alloy tank, and a fuel cell to which hydrogen gas is supplied from the hydrogen storage device to react with air. Electric energy produced by the reaction is extracted from the fuel cell to drive a motor connected to driving wheels. The fuel cell vehicle is thus an ultimate clean vehicle, which discharges only water.

Generally, a cell as a component of PEFC consists of a membrane electrode assembly (MEA) which consists of a polymer electrolyte membrane and electrode catalyst layers provided on both sides thereof, and a pair of separators sandwiching the MEA. As disclosed in Japanese patent application laid-open publication No. 2002-373674, the electrode catalyst layer includes platinum catalysts and carbon catalyst carrier. In some cases, platinum fine particles are applied on the surface of the electrolyte membrane to form the electrode catalyst layer. Since the platinum is expensive, generally the platinum fine particles are applied on the surface of carbon catalyst carrier.

In PEFC, electrode reactions take place between hydrogen gas supplied to an anode (fuel electrode) and air (or oxygen) supplied to a cathode (oxidizer electrode), as expressed by formulas below, whereby electricity is generated:

Anode: H₂→2H₊+2e− (1)

Cathode: 2H₊+2e−+(1/2) O₂→H₂O (2)

### DESCLOSURE OF INVENTION

However, in the above-mentioned fuel cell, when the system is started/shutdown, or while the system is kept stopped, carbon corrosion/poisoning takes place, in which carbon reacts with water in an electrode catalyst layer on a cathode side surface of the electrolyte membrane, whereby the electrolyte membrane and the electrode catalyst are deteriorated.

The carbon corrosion/poisoning will be explained in detail with reference to FIG. 1A and FIG. 1B. FIG. 1A shows reactions of the carbon corrosion/poisoning in a cell at start-up/shutdown of the fuel cell. Conditions under which the reaction takes place at start-up/shutdown of the fuel cell system are listed in the left column of the table of FIG. 1B.

While the fuel cell system is kept stopped, air enters into the anode of the fuel cell. This creates a mixture of oxygen and hydrogen in the anode.

Specifically, when the fuel cell system is stopped, air remains in the cathode of the fuel cell and hydrogen gas remains in the anode thereof. If the fuel cell system is kept stopped, air enters into the anode of the fuel cell. This entering air and the remaining hydrogen gas are mixed in the anode, creating a mixture of oxygen and hydrogen therein. After a long stoppage of the system, the hydrogen gas will be blown out of the anode of the fuel cell by the entering air, and the anode will be filled with air. When starting the supply of the hydrogen gas to start up the system, the hydrogen gas to be supplied is mixed with the air in the anode, creating another situation of mixture of oxygen and hydrogen in the anode.

When the above-described mixtures exist in the anode, and in a region with higher hydrogen concentration, the hydrogen reacts as expressed by formula (3):
H₂→2H₊+2e− (3)

Proton (H₊) thus produced transfers from the anode, crossing over the electrolyte membrane, to the cathode where the proton reacts with the oxygen as expressed by formula (4) to form water:
O₂+4H₊+4e−→H₂O (4)

This reaction requires electron (e−). However, when an external circuit connected to the fuel cell is not closed, the electron freed at the anode cannot transfer to the cathode through the external circuit. Therefore, the water present in the cathode reacts with the catalyst carrier carbon on the electrolyte membrane as expressed by formula (5), whereby carbon dioxide, proton, and electron are produced. The electron thus produced is used for water producing reaction in the cathode (formula (4)).
C+2H₂O→CO₂+4H₊+4e− (5)

By the reaction of formula (5), the carbon on the electrolyte membrane is captured, and the electrolyte membrane is deteriorated.

In a region of the anode with air present therein, the oxygen in the air, the proton produced by the reaction of formula (5) and transferred from the cathode, and the electron generated by the reaction of formula (3) are reacted with one another as expressed by formula (4), to form water.

As an open end voltage of the fuel cell increases, the electrons moves more easily in the fuel cell, and the reactions expressed by formulas (3) to (5) are accelerated. Therefore, the carbon corrosion of the electrolyte membrane becomes severe.

Reaction conditions of corrosion of the platinum catalyst carrier carbon on the electrolyte membrane at shutdown and stoppage of the fuel cell system, will be summarized as follows: air (oxygen) remains in the cathode; hydrogen gas remains in the anode and air (oxygen) enters into the anode from outside; the produced power is not used (power extraction is stopped) and the high open end voltage (see left column of FIG. 1B).

Reaction conditions of the carbon corrosion at start-up of the fuel cell system will be summarized as follows: air (oxygen) enters into the anode from outside; hydrogen gas is supplied to the anode and mixed with the air (oxygen) in the anode; power extraction is stopped until the anode is filled with the hydrogen gas; and the high open end voltage (see left column of FIG. 1B).

The corrosion of the catalyst carrier carbon of the electrolyte membrane affects I-V characteristics of the fuel cell. Specifically, a fuel cell with a catalyst carrier carbon corroded has lower output voltage at an output current than a fuel cell in normal condition, and electric power generated thereby becomes low.

One of measures for preventing the deterioration of the electrolyte membrane and catalyst is to connect temporarily at the start-up of the system to the fuel cell, an auxiliary circuit for consuming power and letting the current flow. Specifically, at start-up of the fuel cell system, the auxiliary circuit having a resistor, etc., is temporarily connected to the fuel cell, thereby preventing surge increase in cell voltage. Thereafter, when the current flowing in the auxiliary circuit reaches a predetermined level, or when the load voltage of the auxiliary circuit drops to a predetermined level, the electrical connection is switched from the auxiliary circuit to a main load circuit.

However, this method requires long time to get the load voltage of the auxiliary circuit lowered, whereby time for the start-up of the fuel cell system becomes long.

Moreover, a fuel cell is easily deteriorated when starting power generation with low hydrogen concentration in the anode thereof.

The present invention was made in the light of the problems. An object of the present invention is to provide a fuel cell system capable of preventing the catalyst deterioration of a fuel cell thereof and reducing the system start-up time, specifically, by reducing the feed rate of fuel gas to prevent an overvoltage, and after that, increasing the feed rate of the fuel gas to complete gas replacement in the anode in a short period of time.

An aspect of the present invention is a fuel cell system, comprising: a fuel gas supply start command unit for commanding start of a fuel gas supply to a fuel cell of the fuel cell system; an operational status detector for detecting an operational status of the fuel cell; a deterioration preventing control unit for performing a control for preventing deterioration of the fuel cell based on output of the operational status detector and output of the fuel gas supply start command unit; and a fuel gas feed rate control unit for controlling fuel gas feed rate according to the output of the fuel gas supply start command unit and the control of the deterioration preventing control unit, wherein the control for preventing deterioration of the fuel cell is performed at start-up of the fuel cell system, wherein the fuel gas supply is started according to the output of the fuel gas supply start command unit, and after the control for preventing deterioration of the fuel cell is started, the fuel gas feed rate is increased by the fuel gas feed rate control unit.

### BRIEF DESCRIPTION OF THE DRAWINGS

The invention will now be described with reference to the accompanying drawings wherein:

FIG. 1A is a schematic view illustrating reactions in a fuel cell at start-up/shutdown;

FIG. 1B is a table showing reaction conditions of carbon corrosion/poisoning at start-up/shutdown/stoppage of the fuel cell, and countermeasures against it;

FIG. 2 is a control block diagram of a fuel cell system according to a first embodiment of the present invention;

FIG. 3 is a system block diagram of the fuel cell system according to the first embodiment of the present invention.

FIG. 4A is a time chart illustrating change in feed rate of hydrogen gas at start-up of a fuel cell system of a comparative example;

FIG. 4B is a time chart illustrating change in a fuel cell voltage at start-up of the fuel cell system of the comparative example;

FIG. 4C is a time chart illustrating status of deterioration preventing control at start-up of the fuel cell system of the comparative example;

FIG. 4D is a time chart illustrating change in amount of oxygen in the cathode at start-up of the fuel cell system of the comparative example;

FIG. 4E is a time chart illustrating change in hydrogen replacement rate in the anode at start-up of the fuel cell system of the comparative example;

FIG. 5A is a time chart illustrating change in feed rate of hydrogen gas at start-up of the fuel cell system of the first embodiment;

FIG. 5B is a time chart illustrating change in a fuel cell voltage at start-up of the fuel cell system of the first embodiment;

FIG. 5C is a time chart illustrating status of deterioration preventing control at start-up of the fuel cell system of the first embodiment;

FIG. 5D is a time chart illustrating change in amount of oxygen in the cathode at start-up of the fuel cell system of the first embodiment;

FIG. 5E is a time chart illustrating change in hydrogen replacement rate in the anode at start-up of the fuel cell system of the first embodiment;

FIG. 6 is a general flow chart illustrating a start-up control sequence of the fuel cell system according to the first embodiment;

FIG. 7 is a flow chart illustrating hydrogen feed rate increase determination processing according to the first embodiment;

FIG. 8 is a flow chart illustrating hydrogen feed rate increase determination processing according to the second embodiment; and

FIG. 9 is a flow chart illustrating hydrogen feed rate increase determination processing according to the third embodiment.

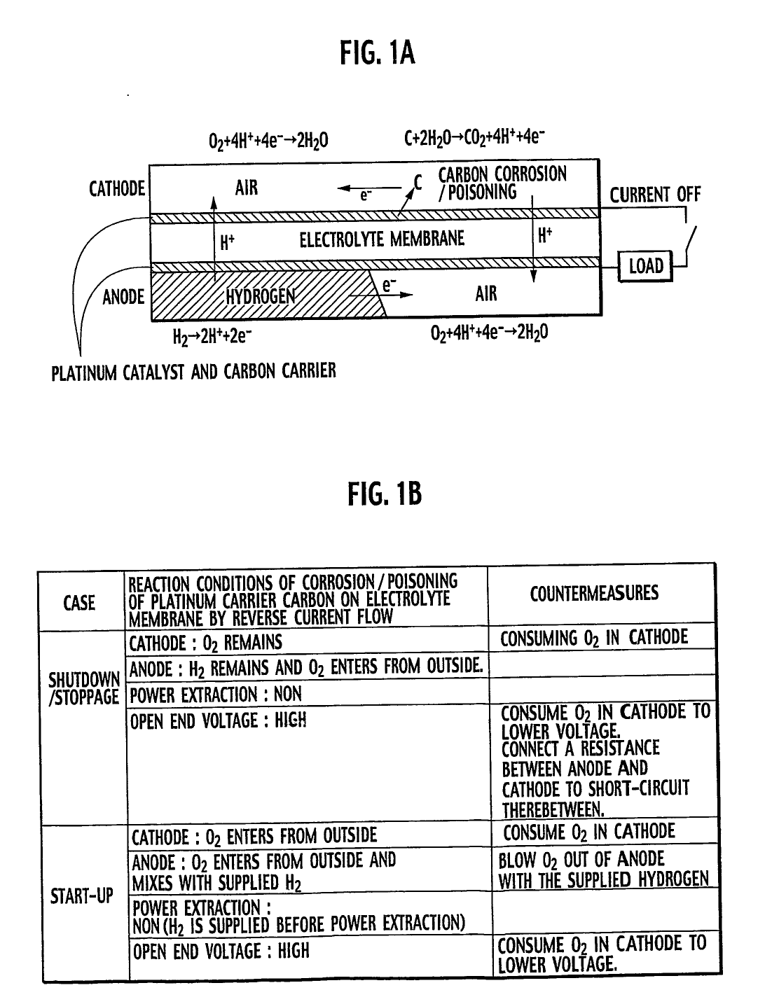

### BEST MODE FOR CARRYING OUT THE INVENTION

The preferred embodiments of the present invention will be explained with reference to the drawings. Each of the embodiments as will be explained hereunder is a fuel cell system suitable for a fuel cell vehicle.

### FIRST EMBODIMENT

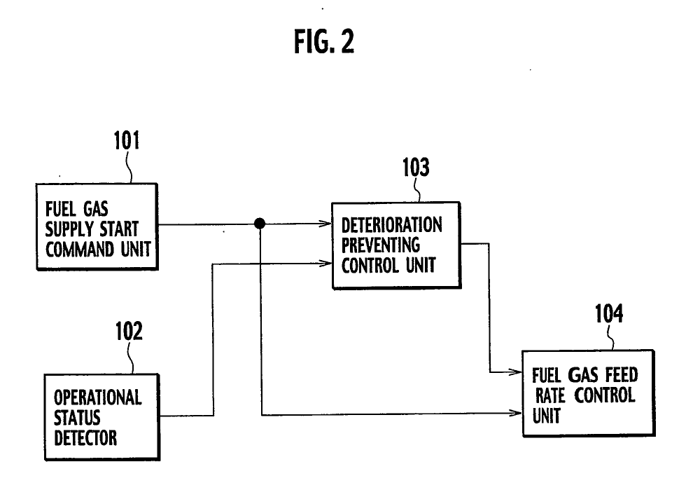

As shown in FIG. 2, a fuel cell system according to a first embodiment of the present invention comprises:

a fuel gas supply start command unit 101 for commanding start of fuel gas supply to a fuel cell of the fuel cell system;

an operational status detector 102 for detecting the operational status of the fuel cell;

a deterioration preventing control unit 103 for performing a control for preventing deterioration of the fuel cell based on output from the fuel gas supply start command unit 101 and output from the operational status detector 102; and

a fuel gas feed rate control unit 104 for controlling fuel gas feed rate according to the output of the fuel gas supply start command unit 101 and the control of the deterioration preventing control unit 103.

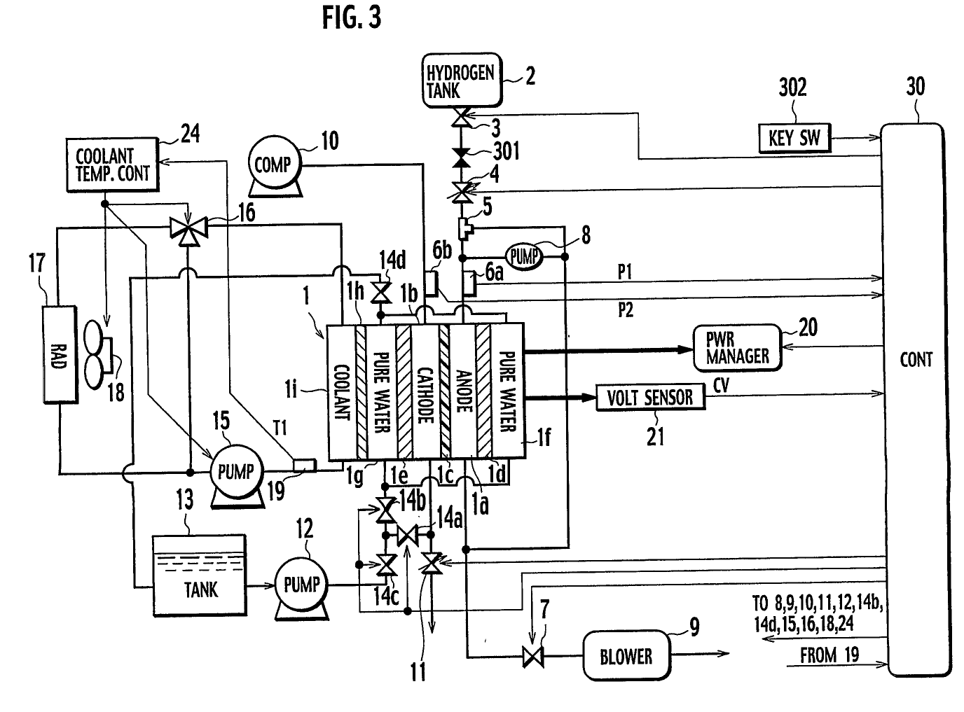

In the fuel cell system according to a first embodiment, the operational status detector 102 of FIG. 2 is realized as a voltage sensor 21 for detecting the voltage of a fuel cell 1 of FIG. 3, and the fuel gas supply start command unit 101 and the deterioration preventing control unit 103 and the fuel gas feed rate control unit 104 of FIG. 2 are realized as a part of a controller 30 for controlling operation of the entire fuel cell system of FIG. 3.

The controller 30 is a microprocessor having CPU, ROMs which store control programs and parameters, RAMs as working storage memories, and an input/output interface.

In FIG. 3, the fuel cell (fuel cell main body) 1 is, but not limited to, an internal humidifying type and has an anode 1a, a cathode 1b, an electrolyte membrane 1c, porous separators 1d and 1e, flow passages of pure water 1f and 1g through which pure water for humidifying reaction gas passes, a flow passage of coolant 1i, and a separator 1h separating the flow passage of pure water 1g and the flow passage of coolant 1i.

Hydrogen gas is supplied to the anode 1a from a hydrogen tank 2 through a hydrogen tank main valve 3, a pressure reducing valve 301, and a hydrogen supplying valve 4. Pressure of the hydrogen tank 2 is reduced to a predetermined intermediate pressure by the pressure reducing valve 301, and thereafter, pressure of the hydrogen gas is regulated by the hydrogen supplying valve 4 to a desired hydrogen pressure, and the regulated hydrogen gas is supplied to the anode 1a.

The fuel cell system is controlled by the controller 30 which performs air pressure control for the cathode 1b, hydrogen pressure control for the anode 1a, pure water collecting control for collecting pure water to a pure water tank 13 at shutdown of the fuel cell under a low temperature environment, and cathode oxygen consumption control for controlling oxygen consumption in the cathode at start-up of the fuel cell.

A coolant temperature control unit 24 receives command from the controller 30, and controls a coolant pump 15, three-way valves 16, and a radiator fan 18, so that a fuel cell temperature T1 detected by a temperature sensor 19 provided at a coolant outlet of the fuel cell 1, is adjusted to be a desired temperature.

An ejector 5 and a hydrogen circulating pump 8 are fuel gas circulating devices for re-circulating fuel gas to the anode 1a. The gas to be supplied to the anode is a mixture of new hydrogen gas supplied through the hydrogen supplying valve 4 and unused hydrogen gas discharged from the anode 1a. The hydrogen circulating pump 8 works to cover a range of hydrogen flow rate out of working range of the ejector 5.

The hydrogen pressure at the anode 1a is controlled by the controller 30 which performs a feed back control over pressure P1 detected by a pressure sensor 6a, driving the hydrogen supplying valve 4. By controlling the hydrogen pressure to be constant, the hydrogen gas used in the fuel cell 1 is automatically compensated.

A purge valve 7 is provided between the anode 1a and a dilution blower 9. The purge valve 7 opens in the cases (a) to (c): (a) Discharging nitrogen accumulated in a fuel gas system to ensure circulation of hydrogen. (b) Blowing water accumulated in a gas passage to recover cell voltage. (c) Performing a cathode oxygen consumption control at start-up or shutdown of the fuel cell system, in which hydrogen gas is supplied only to the anode 1a to consume oxygen in the cathode 1b, and replacing gas in the fuel gas system with hydrogen gas to prevent deterioration of the fuel cell.

The dilution blower 9 dilutes a gas containing hydrogen discharged from the purge valve 7 with air, reduces the hydrogen concentration thereof to below a noncombustible range, and discharges the diluted gas outside the system.

Air is fed to the cathode 1b by a compressor 10. Air pressure P2 at the cathode 1b is detected by a pressure sensor 6b provided at cathode inlet side. The controller 30 controls air pressure of the cathode to a desired value, performing feedback control over the air pressure P2 detected by the pressure sensor 6b and driving an air pressure regulating valve 11.

Humidifying pure water in the pure water passages 1f and 1g is supplied from the pure water tank 13 by a pure water pump 12. Air pressure, hydrogen pressure, and pure water pressure are determined, taking power generating efficiency and water balance into consideration, and adjusted to a predetermined pressure so that strains are not generated in the electrolyte membrane 1c and the separators 1d and 1e. Some water in the pure water passages 1f and 1g passes through the porous separators 1d and 1e, to humidify the hydrogen gas in the anode and the air in the cathode, respectively. Unused pure water returns to the pure water tank 13 through the pure water shut valve 14d.

If the fuel cell system is stopped with pure water remained in the pure water passages 1f and 1g, expansion of the pure water by freezing occurs at the temperature below freezing point, and in this case, the fuel cell 1 is possibly damaged. Therefore, when the system is stopped, the pure water is collected to the pure water tank 13. The controller 30 sends the air pressure, which is normally applied to the cathode 1b by the compressor 10, to the pure water passages 1f and 1g and pure water piping, blows the pure water therein and returns the pure water to the pure water tank 13. The pure water tank 13 has an improved structure and can be used even if the pure water is frozen in the inside.

A pure water shut valve 14d is a shut-off valve which prevents gas leakage into the pure water pipe line. When the hydrogen gas is supplied to the anode 1a, with no pure water in the pure water passages 1f and 1g at start-up or shutdown of the fuel cell system, the hydrogen leakage into the pure water piping can be prevented by closing a pure water collecting valve 14b and the pure water shut valve 14d.

The coolant is supplied to a coolant passage 1i in the fuel cell 1 by the coolant pump 15. Three-way valves 16 switches the passage of the coolant, guides the coolant to either of a radiator 17 or a radiator bypass, or to both of them in parallel. The radiator fan 18 forcibly sends air to the radiator 17 to cool the coolant, when the coolant is not sufficiently cooled by natural airflow at traveling. The coolant temperature control unit 24 adjusts the temperature of the coolant by performing feedback of the temperature of the coolant detected by the temperature sensor 19 and driving the three-way valves 16 and the radiator fan 18.

A power manager 20 extracts electric power from the fuel cell 1 and supplies the extracted power to a load device such as a vehicle driving motor (not shown).

In the control for preventing deterioration of the fuel cell performed at start-up or shutdown of the fuel cell system, the controller 30 extracts electric power from the fuel cell to consume oxygen of the cathode according to the fuel cell voltage CV and the elapsed time detected by the voltage sensor 21.

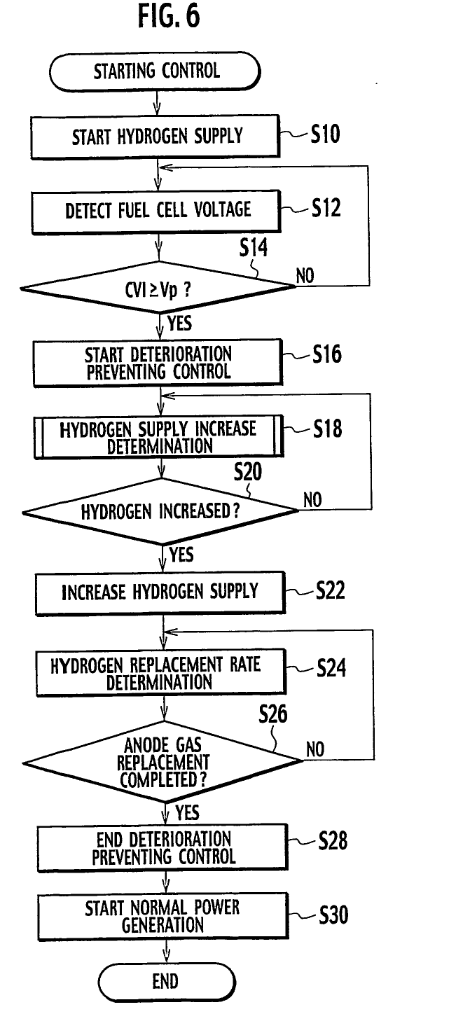

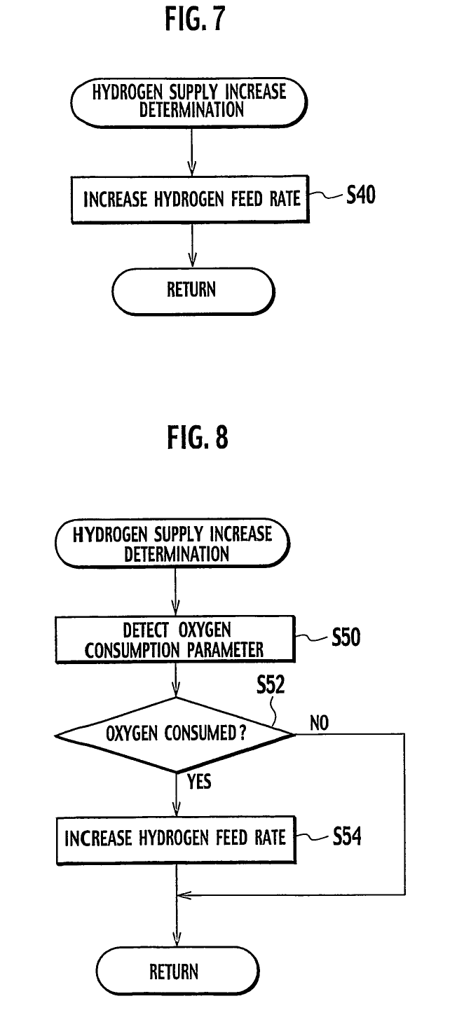

Next, explanation will be given to the control in the fuel cell system of the first embodiment at start-up, with reference to the flow charts of FIG. 6 and FIG. 7. FIG. 6 is a general flow chart of the control by the controller 30 at start-up of the fuel cell system in the first embodiment, and FIG. 7 is a flow chart of the determination of hydrogen gas flow rate increase.

As a condition of the system before the control of the flow chart of FIG. 6 is started, the main valve 3 of the hydrogen tank is closed, the compressor 10 is stopped, and hydrogen and air are not supplied to the fuel cell 1 yet.

In FIG. 6, first, in step S10, the fuel gas supply start command unit 101 determines to start a hydrogen gas supply based on signals from various vehicular devices such as a key switch 302, sends a signal for adjustment of the hydrogen supply pressure, such as a setting pressure for idling of the system, to the hydrogen supply valve 4, and sends a signal for opening the main valve 3 of the hydrogen tank 2, whereby the hydrogen gas is started to be supplied to the anode 1a of the fuel cell 1 from the hydrogen tank 2. Next, in step S12, a cell group voltage or a total voltage CV1 of the fuel cell 1 is detected by the voltage sensor 21 (operational status detector 102), and the detected voltage is read in the sequence controller 30.

In step S14, based on the detected voltage of step S12, it is determined whether or not the deterioration preventing control is started. In the determination, the detected voltage CV1 and a predetermined value Vp are compared, and if the detected voltage is equal to or greater than the predetermined value Vp, the process is advanced to step S16, and the deterioration preventing control is started. The predetermined value Vp is called a deterioration preventing control start threshold value.

Here, if the voltage sensor 21 detects voltages of a plurality of cell groups of the fuel cell 1, the maximum value of the detected voltages is defined as the detected voltage CV1, and this voltage CV1 and the predetermined value Vp are compared.

The predetermined value Vp to be compared, is set to be smaller (Vp<Vd) than a deterioration threshold value Vd, which is a voltage at which the deterioration of the fuel cell 1 is caused, and which is previously obtained by an experiment, etc. When the detected voltage CV1 is below the predetermined value Vp in step S14, the process is returned to step S12.

In step S16, the deterioration preventing control is started so as to prevent deterioration of the fuel cell. The deterioration preventing control unit 103 performs the deterioration preventing control, in which supply of the hydrogen gas to the anode 1a is continued while supply of air to the cathode 1b is stopped, and a command is sent out to the power manager 20 to extract the electric power from the fuel cell 1 for consuming the oxygen in the cathode.

Extraction of the electric power (current) from the fuel cell 1 in the deterioration preventing control in step S16 may be realized by the power manager 20 as described above, which is a load device at the time of normal power generation, or by a method connecting resistors or the like, which is separately prepared, to the fuel cell 1.

Next, it is determined in step S18 whether or not the hydrogen gas flow rate to be supplied to the anode la is increased. In the step S20, a determination result of the step S18 is judged.

Determination of the increase in the hydrogen gas flow rate in step S18 will be explained later with reference to FIG. 7.

When it is determined in step S20 that the hydrogen gas flow rate is not increased, the process is returned to step Sl8.

When it is determined in step S20 that the hydrogen gas flow rate is increased, the process is advanced to step S22.

In step S22, the flow rate of hydrogen gas supplied to the anode 1a is increased by increasing the hydrogen supply pressure, the command to increase the hydrogen supply pressure is sent out to the hydrogen supply valve 4.

Increase in the flow rate of the hydrogen gas in step S22 may be realized by increasing a target pressure value of the hydrogen gas supplied from the hydrogen supply valve 4, or may be realized by increasing an opening of the purge valve 7 for discharging the hydrogen gas.

In addition, a plurality of valves (at least a valve for low flow rate and a valve for high flow rate) which respectively have openings different in size and are different in flow rate at the time of opening the valve, are provided at the anode outlet, and the valve for use may be switched from the valve for low flow rate to the valve for high flow rate.

Next, the hydrogen gas replacement rate in the anode 1a is determined in step S24. In the step S26, it is determined whether or not the anode gas replacement is ended.

When it is determined in step S26 that the hydrogen replacement of the anode 1a is not ended, the process is returned to step S24. When it is determined in step S26 that the hydrogen replacement of the anode 1a is ended, the process is advanced to step S28, and the deterioration preventing control is ended. Then, in step S30, normal power generation is started and air and hydrogen gas required for the power generation is supplied to the fuel cell and the start-up control is ended.

FIG. 7 is a flow chart showing procedures of the determination of hydrogen gas flow rate increase in step S18 of FIG. 6. In this embodiment, when the deterioration preventing control is started, the hydrogen gas flow rate is increased at the same time. In step S40, it is determined that the hydrogen gas flow rate is unconditionally increased, and the process is returned to main routine.

### SECOND EMBODIMENT

Next, explanation will be given to a start-up control of the fuel cell system according to a second embodiment of the present invention, with reference to the flow chart of FIG. 8. The structure of the fuel cell system of the second embodiment is the same as the structure of the first embodiment shown in FIG. 2 and FIG. 3. The general flow chart of FIG. 6 is the same as that of the first embodiment, and therefore only FIG. 8 will be explained.

FIG. 8 shows procedures in step S18 of FIG. 6. In this embodiment, after the deterioration preventing control is started, and if it is determined in step S18 that the oxygen of the cathode is consumed (cathode oxygen consumption determination unit), the hydrogen gas flow rate is increased.

In step S50 of FIG. 8, an oxygen consumption parameter for determining the consumption of the oxygen of the cathode is detected. In Step S52, it is determined whether or not the oxygen of the cathode is consumed based on the detected oxygen consumption parameter.

If it is determined in step S52 that the oxygen of the cathode is consumed, and the hydrogen gas flow rate is increased in step S54, and the process is returned to the main routine.

If it is determined in step S52 that the oxygen of the cathode is not consumed, the process is returned to the main routine, skipping the step of determining increase in the hydrogen gas flow rate.

The oxygen consumption parameter detected by step S50 may be the maximum value of the voltages of the plurality of cell groups each of which consists of a plurality of cells of the fuel cell 1, or may be the total voltage of the fuel cell.

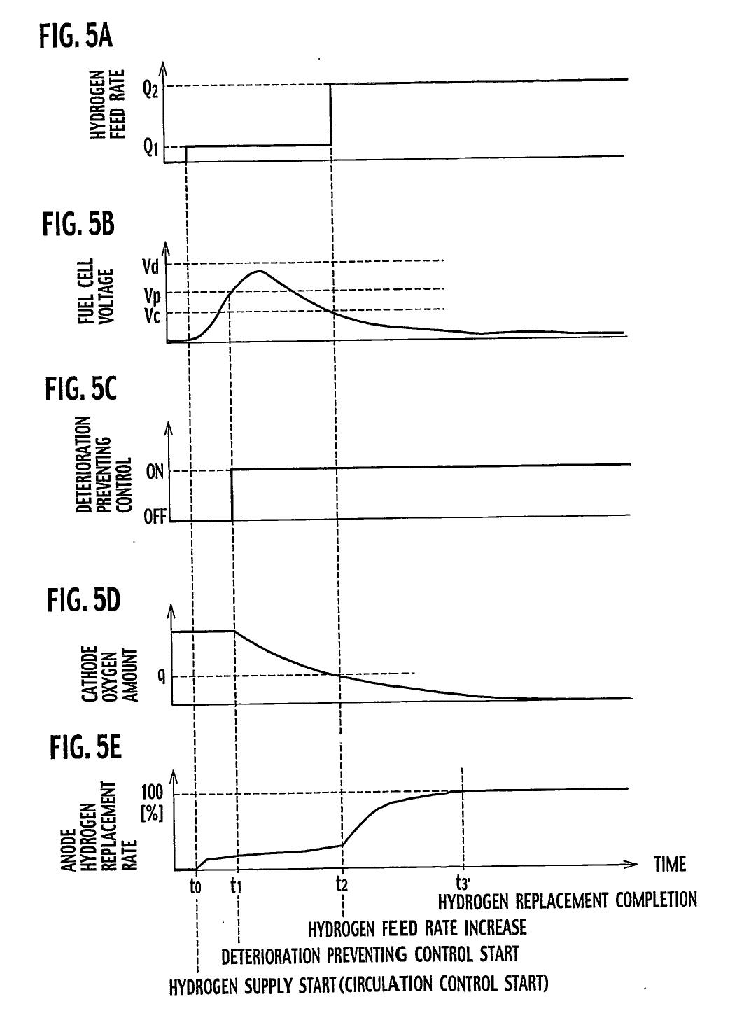

In the case that the oxygen consumption parameter is defined as the maximum value of the cell group voltages or the total voltage of the fuel cell, it is determined in step S52 that the oxygen in the cathode is consumed by an amount equal to or greater than a predetermined amount, if the maximum value of the cell group voltages or the total voltage of the fuel cell falls below the predetermined oxygen consumption determining threshold value Vc (FIG. 5B).

Moreover, if oxygen in the air of the cathode is consumed, the hydrogen transferred from the anode to the cathode by crossing over the electrolyte membrane 1c cannot react with the oxygen. A hydrogen detection sensor is provided downstream the air pressure regulating valve 11, and by this sensor, if the hydrogen is detected in the air passage, signals from the hydrogen detection sensor may be defined as the oxygen consumption parameter.

In addition, a current sensor is provided to detect an output current of the fuel cell 1, and the amount of oxygen consumed can be estimated from an integral current value calculated from the detected current. In this case, an amount of oxygen need to be consumed in the cathode is calculated from volume and pressure of the air system.

In addition, the time elapsed from start of extracting electric power for preventing deterioration is measured, and the time thus obtained may be defined as the oxygen consumption parameter. These methods may be used solely or in combination with the others.

In the case that it is determined that oxygen of the cathode is consumed if the fuel gas is detected in the cathode air passage, it is possible to detect complete consumption of the oxygen.

In the case that it is determined that oxygen of the cathode is consumed, when the predetermined time has elapsed since the deterioration preventing control is started, the construction of control software can be simple.

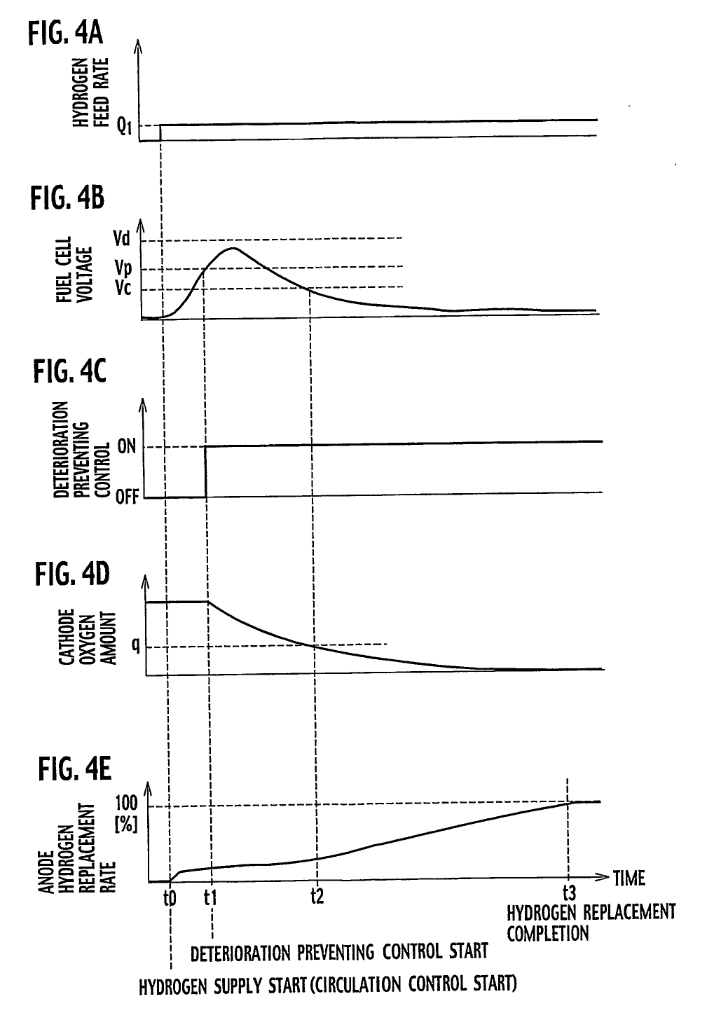

FIGS. 4A to 4D are time charts as comparative examples, showing the start-up control of the fuel cell, in which the hydrogen gas flow rate is set to be a low flow rate Q1 from the start of supply to the completion of the hydrogen replacement in the anode.

When the supply of the fuel gas (hydrogen gas) is started (time t0) to the fuel cell at a predetermined flow rate Q1 (or pressure) and the cell group voltage or the total voltage exceeds the deterioration preventing control start threshold value Vp, the deterioration preventing control is started (time t1). Accordingly, power generation is started, and the oxygen amount in the cathode starts decreasing. Since the hydrogen gas flow rate is suppressed to be a low flow rate Q1, so that the voltage of the fuel cell is held below the predetermined deterioration threshold value Vd, long time is required from start of the supply to complete the hydrogen replacement in the anode (time t3). Therefore, the process cannot advance to the next process, and long time is required for starting the system.

In the second embodiment, as shown in FIGS. 5A to 5D, when the supply of the fuel gas (hydrogen) to the fuel cell is started (time t0) at the predetermined flow rate Q1 (or pressure), and the cell group voltage or the total voltage of the fuel cell exceeds the deterioration preventing control start threshold value Vp, the deterioration preventing control is started (time t1). Thereafter, when the oxygen amount in the cathode lowers to an upper limit value q below which the deterioration of the fuel cell can be avoided, the flow rate of the hydrogen gas is increased to a predetermined flow rate Q2. Thus, when the flow rate of the hydrogen gas supplied to the anode is increased, the time from the start of supply of the hydrogen gas to completion of the hydrogen replacement in the anode (time t3′<time t3) can be shortened, and the start-up time of the system can also be shortened without deterioration of the fuel cell.

### THIRD EMBODIMENT

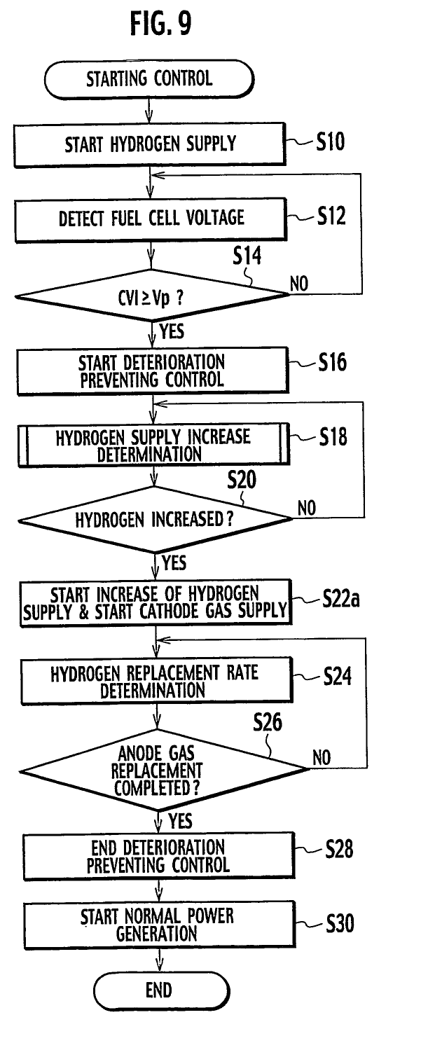

Next, explanation will be given to the control at start-up in the fuel cell system according to a third embodiment of the present invention, with reference to the flow chart of FIG. 9. The structure of the fuel cell system of the third embodiment is the same as the structure of the first embodiment as shown in FIG. 2 and FIG. 3.

In this embodiment, the controller 30 of FIG. 3 serves as a cathode gas supply start command unit for commanding the start of the air (cathode gas) supply, and also serves as a deterioration possibility determination unit for determining the possibility of the deterioration of the fuel cell based on output of the operational status detector 102.

FIG. 9 is a general flow chart for explaining the control of the fuel cell system of this embodiment at start-up.

For control steps executing the same processing as that of control steps in the general flow chart (FIG. 6) of the first embodiment, the same reference signs and numerals are used, the overlapping explanations thereof are omitted, and only difference in the general flow chart between this embodiment and the first embodiment will be explained.

In this embodiment, the hydrogen supply pressure is increased to increase the hydrogen gas flow rate to the anode 1a. The command of increasing the hydrogen supply pressure is sent out to the hydrogen supply valve 4 in step S22a that follows step S20 where the hydrogen gas flow rate is determined to be increased. Further, in step S22a, the compressor 10 is started to supply air to the cathode 1b.

In this embodiment, based on a determination result of the increase in hydrogen gas flow rate in step S18, it is determined that there is less possibility of the deterioration of the fuel cell, and the air supply to the cathode 1b is allowed.

Increase in the flow rate of the hydrogen gas in step S22a may be realized, similarly to the first embodiment, by increasing a target pressure value of the hydrogen gas supplied through the hydrogen supply valve 4, or may be realized by increasing an opening of the purge valve 7 for discharging the hydrogen gas.

In addition, a plurality of valves (at least a valve for low flow rate and a valve for high flow rate) which respectively have openings different in size and are different in flow rate at the time of opening the valve, are provided at the anode outlet, and the valve for use may be switched from the valve for low flow rate to the valve for high flow rate.

In this embodiment, based on a determination result of the increase in hydrogen gas flow rate in step S18, it is determined that there is less possibility of the deterioration of the fuel cell, and the air supply to the cathode 1b is allowed. Accordingly, the start-up of the fuel cell system can be shortened by starting the air supply to the cathode 1b before completing the hydrogen replacement of the anode 1a.

Note that it is not necessary to start the air supply to the cathode 1b at the time when the flow rate of the hydrogen gas is increased. If it is previously obtained by an experiment etc. a time required for the hydrogen gas in the anode to be dispersed in a range where the deterioration of the fuel cell can be avoided, timing of starting the air supply to the cathode 1b can be determined based on the elapsed time from start of the hydrogen gas supply or the increase in the flow rate of the hydrogen gas.

In addition, in the case that priming the pure water pump 12 is performed by sending the compressed air, which is supposed to be sent to the cathode 1b, to the pure water tank 13, an additional time is required for starting the fuel cell system. In this embodiment, since the compressor 10 is started before completing the hydrogen replacement, the time required for starting the fuel cell system is further shortened.

The present disclosure relates to subject matters contained in Japanese Patent Application No. 2003-396795, filed on Nov. 27, 2003, and Japanese Patent Application No. 2004-090115, filed on Mar. 25, 2004, the disclosure of which are expressly incorporated herein by reference in their entirety.

The preferred embodiments described herein are illustrative and not restrictive, and the invention may be practiced or embodied in other ways without departing from the spirit or essential character thereof. The scope of the invention being indicated by the claims, and all variations which come within the meaning of claims are intended to be embraced herein.

### INDUSTRIAL APPLICABILITY

In a fuel cell system according to the present invention, at start-up thereof, hydrogen gas supply to a fuel cell 1 is first started, and when the voltage of the fuel cell 1 detected by a voltage sensor 21 reaches a predetermined value, a deterioration preventing control is started in which power is extracted from the fuel cell 1 while the hydrogen gas supply to anode 1a is continued and air supply to the cathode 1b is stopped. Then, when it is determined that oxygen in the cathode 1b is consumed, flow rate of the hydrogen gas supplied to the anode 1a is increased.

According to the fuel cell system, since the flow rate of the hydrogen gas is increased after the deterioration preventing control is started, gas in the anode can be quickly replaced with hydrogen gas without causing deterioration of the fuel cell. Also, the fuel cell system can be applied to a technique for shortening start-up time while preventing corrosion/poisoning of a catalyst carrier carbon on the electrolyte membrane at start-up of the fuel cell system.

1. A fuel cell system, comprising:
a fuel gas supply start command unit for commanding start of a fuel gas supply to a fuel cell of the fuel cell system;
an operational status detector for detecting an operational status of the fuel cell;
a deterioration preventing control unit for performing a control for preventing deterioration of the fuel cell based on output of the operational status detector and output of the fuel gas supply start command unit; and
a fuel gas feed rate control unit for controlling fuel gas feed rate according to the output of the fuel gas supply start command unit and the control of the deterioration preventing control unit,
wherein the control for preventing deterioration of the fuel cell is performed at start-up of the fuel cell system,
wherein the fuel gas supply is started according to the output of the fuel gas supply start command unit, and after the control for preventing deterioration of the fuel cell is started, the fuel gas feed rate is increased by the fuel gas feed rate control unit.

2. The fuel cell system according to claim 1, wherein the fuel gas feed rate control unit increases the fuel gas feed rate immediately after the control for preventing deterioration of the fuel cell is started by the deterioration preventing control unit.

3. The fuel cell system according to claim 1, further comprising:
a cathode oxygen consumption determination unit for determining whether or not oxygen in a cathode of the fuel cell is consumed, based on the output of the operational status detector,
wherein, in the control for preventing deterioration of the fuel cell, the deterioration preventing control unit consumes oxygen in the cathode by extracting power from the fuel cell while air supply to the cathode is stopped, and
the fuel gas feed rate control unit increases the fuel gas feed rate, after it is determined by the cathode oxygen consumption determination unit that the oxygen of the cathode is consumed.

4. The fuel cell system according to claim 3, wherein
the operational status detector comprises a voltage sensor for sensing voltages of a plurality of cells of the fuel cell, and
the cathode oxygen consumption determination unit determines that oxygen of the cathode is consumed, if the maximum value of the voltages of the plurality of cells sensed by the voltage sensor is below a predetermined value.

5. The fuel cell system according to claim 3, wherein
the operational status detector comprises a voltage sensor for sensing a total voltage of the fuel cell, and
the cathode oxygen consumption determination unit determines that oxygen of the cathode is consumed, if the total voltage sensed by the voltage sensor is below a predetermined value.

6. The fuel cell system according to claim 3, wherein
the operational status detector comprises a fuel gas detector for detecting fuel gas present in an air passage in the fuel cell; and
the cathode oxygen consumption determination unit determines that the oxygen of the cathode is consumed, if the fuel gas detector detects fuel gas present in the air passage.

7. The fuel cell system according to claim 3, wherein
the operational status detector comprises a current detector for detecting output current of the fuel cell; and
the cathode oxygen consumption determination unit estimates an amount of oxygen consumed based on a detected value obtained by the current detector, and determines that the oxygen of the cathode is consumed, if the estimated amount of oxygen consumed becomes greater than a predetermined value.

8. The fuel cell system according to claim 3, wherein
the cathode oxygen consumption determination unit determines that the oxygen of the cathode is consumed, if a predetermined time elapsed since the control for preventing deterioration of the fuel cell is started.

9. The fuel cell system according to claim 1, wherein
the fuel gas feed rate control unit performs variable control of the fuel gas feed rate by changing a target pressure value of the fuel gas.

10. The fuel cell system according to claim 1, wherein
the fuel gas feed rate control unit performs variable control of the fuel gas feed rate by changing opening of a valve for discharging the fuel gas from an anode.

11. The fuel cell system according to claim 1, further comprising:
a plurality of valves for discharging fuel gas from an anode of the fuel cell, having openings different in size,
wherein the fuel gas feed rate control unit performs variable control of the fuel gas feed rate by switching the valves to be opened.

12. The fuel cell system according to claim 1, wherein
the deterioration preventing control unit holds voltage of the fuel cell below a predetermined value, by extracting power from the fuel cell and feeding the power to a load device to which the power is fed at normal time at start-up and/or shutdown of the fuel cell system.

13. The fuel cell system according to claim 1, wherein
the deterioration preventing control unit holds voltage of the fuel cell below a predetermined value, by extracting power from the fuel cell and feeding the power to an auxiliary load device at start-up and/or shutdown of the fuel cell system.

14. The fuel cell system according to claim 1, further comprising:
a cathode gas supply start command unit for commanding start of cathode gas supply to the fuel cell; and
a deterioration possibility determination unit for determining the possibility of deterioration of the fuel cell, based on the output of the operational status detector,
wherein the cathode gas supply start command unit commands the start of the cathode gas supply if it is determined by the deterioration possibility determination unit that there is less possibility of deterioration of the fuel cell.

15. A method for starting up a fuel cell system, comprising:
supplying fuel gas to a fuel cell;
detecting an operational status of the fuel cell;
performing a control for preventing deterioration of the fuel cell based on the detected operational status after starting the supply of the fuel gas; and
increasing feed rate of the fuel gas to be supplied to the fuel cell after starting the control for preventing deterioration of the fuel cell.
